(19) United States
(12) Patent Application Publication
(10) Pub. No.: US 2006/0044613 A1
(43) Pub. Date: Mar. 2, 2006

(54) Image data management apparatus, and method, program and storage medium therefor

(75) Inventors: Hideki Hirose, Oota-ku (JP); Kei Morita, Kawasaki-shi (JP); Eijiro Atarashi, Toride-shi (JP); Takahiro Haraguchi, Kawasaki-shi (JP); Tadashi Kawaguchi, Shinagawa-ku (JP); Fumio Mikami, Chigasaki-shi (JP)

Correspondence Address: Canon U.S.A. Inc.;Intellectual Property Division, 15975 Alton Parkway, Irvine, CA, 92618-3731, US

(73) Assignee: Canon Kabushiki Kaisha, Ohta-ku (JP)

(21) Appl. No.: 11/196,938

(22) Filed: Aug. 4, 2005

(30) Foreign Application Priority Data
Aug. 26, 2004 (JP) 2004-246617

(51) Int. Cl. G06K 15/00

(52) U.S. Cl. 358/1.16

(57) ABSTRACT

Disclosed is an image forming apparatus that can restore a defective area on a storage medium, and can appropriately and immediately notify the user of image data which image data written in the defective area have been destroyed. To accomplish this, when the detection of a defective sector has been started, and a defective sector is detected, a CPU is notified of the logic block address of the defective sector, and a replacement prepared in a spare area is allocated to restore the defective sector. When image data is present in the defective sector, an image data file name pertinent to the logic block address of the defective sector is stored. And when the detection process has been completed up to the last sector, an email is transmitted to the box user pertinent to the logic block address for the defective sector.

### BACKGROUND OF THE INVENTION

1. Field of the Invention

The present invention relates to an image data management apparatus including a notification unit for detecting a defective area on a storage unit and for providing a notification to that effect, and a method, a program, and a storage medium therefor.

2. Description of the Related Art

Consonant with the recent digitization of copiers, multi-functional apparatuses have been developed and put to practical use that provide a plurality of functions, such as a facsimile transmission/reception function, for which the scanner or the printer of a copier is employed, and a Page Description Language (PDL) printing function. These multi-functional apparatuses are designed to perform not only a single function, such as a copying function, a facsimile function or a PDL printing function, but also a multi-complex function, such as the facsimile transmission, for example, of a PDL expanded image. Furthermore, the multi-functional apparatuses are also designed so that when connected to a Local Area Network (LAN), their functions can, for example, be used by a computer. The multi-functional apparatuses also include a function for converting an image read by a scanner into a PDF file, for example, and for transmitting the PDF file, as an email attachment, to a specific email address.

For a multi-functional apparatus, a control program for a printer portion can be employed in common for the copying function, the PDL printing function and the facsimile printing function, and a control program for a reader portion can be employed in common for the copying function, the facsimile reading function and the scanner function. As a result, the memory capacity required for the control programs that provide the various functions can be reduced and desired functions can be provided economically and easily.

Further, a multi-functional apparatus includes an image storage unit, such as a hard disk or a semiconductor memory having a large capacity, for storing image data. A desired function can be provided by performing, relative to the image storage unit, both an image input job for inputting, to the image storage unit, image data read by the scanner and PDL expanded image data and document data received via facsimile, and an image output job for reading image data from the image storage unit for printing, for facsimile transmission, or for transfer to a computer via a network.

A box function, which uses part of a large capacity hard disk whereon image data are stored, can also be provided for the temporary storage of image data and for the reading of the image data at a desired timing. To implement the box function, one hundred boxes, for example, are prepared in a fixed area on a hard disk, and when, at the request of a user, image data are fetched from a computer connected to the multi-functional apparatus, the user need only designate a box number for the image data to be stored in the corresponding box. Whether a password comparison procedure need be performed can be established for each box, individually, and a name can also be designated for each box.

A hard disk is currently employed as the storage medium for this type of box function. And when, for example, the main power is cut off during the writing of data, or because an unexpected event occurs due to some type of physical shock, a defective area (hereinafter called a defective sector) wherein data writing and reading are disabled may be created on a hard disk. If the writing and reading of image data is continued without corrective action being taken for the defective sector, either image data written in the defective area would be lost and an incomplete image reproduced, or in the worst case, a time out would occur due to data reading retry and a service call would be issued.

Therefore, a method is disclosed in Japanese Laid Open Patent No. 11-088623 in which a defective sector on a hard disk can be detected, and, when a defective sector is detected, a formatting process is performed and a message to that effect is displayed.

However, according to this conventional method, when a defective sector, that was created in an area in which data had previously been written, is restored, image data included in the defective sector are invalid. However, the user of the invalid image data is not aware of this unless he/she is beside a copier. In other words, the user of image data who is having the image data printed will be aware that an illegal image has been output or that a service call has been issued.

### SUMMARY OF THE INVENTION

Accordingly, the present invention provides an image data management apparatus, an image data management method, a program and a storage medium that can restore a defective sector created in an area in which data have previously been written, that can specify the user of image data that are invalid and that can appropriately and immediately provide a notification for the user to the effect that the image data are invalid.

According to an aspect of the present invention, an image data management apparatus, connected to a network, includes: a storage unit adapted to store image data; a detection unit adapted to detect a defective area in the storage unit; a management unit adapted to manage information indicating a correlation between a predetermined area in the storage unit and a user corresponding to the predetermined area in the storage unit; and a notification unit adapted to notify the user corresponding to the predetermined area of information indicating a state of the predetermined area when a defective area in the storage unit detected by the detection unit and the defective area in the storage unit is in the predetermined area.

Other features of the present invention will be apparent from the following description taken in conjunction with the accompanying drawings, in which like reference characters designate the same or similar parts throughout the figures there.

### BRIEF DESCRIPTION OF THE DRAWINGS

FIG. 1 is a diagram showing the general configuration of an exemplary complex system;

FIG. 2 is a cross-sectional view of the printer section of a multi-functional apparatus;

FIG. 3 is a block diagram showing the controller of the multi-functional apparatus;

FIG. 4 is a functional block diagram showing the Application-Specific Integrated Circuit (ASIC) of the multi-functional apparatus;

FIG. 5 is a flowchart showing a processing sequence, performed by the multi-functional apparatus, for detecting and restoring a defective sector and transmitting an email to a sender;

FIG. 6 is a diagram showing a table wherein correlation of box numbers and email addresses of users of corresponding boxes is managed by the multi-functional apparatus; and

FIG. 7 is a diagram showing the processing, performed by the multi-functional apparatus, for allocating a defective sector to a replacement sector in a spare area on a hard disk.

### DESCRIPTION OF THE EMBODIMENTS

Exemplary embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

An image data management apparatus according to exemplary embodiments is applied for a copier that includes a function as a multi-functional apparatus (MFP).

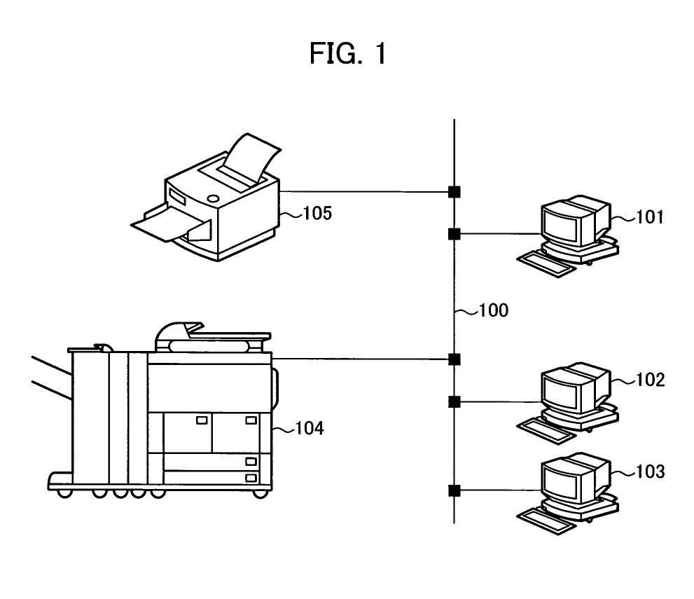

FIG. 1 is a diagram showing the configuration of a complex network system. In FIG. 1, host computers 101 to 103 are network terminal apparatuses, and a copier 104 and a printer 105 are apparatuses having several different functions, such as the functions of a color printer, a monochrome printer, a laser printer, an ink jet printer and a multi-functional apparatus. The apparatuses 101 to 105 are connected to a network 100, and print data prepared by the host computers 101 to 103 can be printed, via the network 100, by the printer 105 and the copier 104.

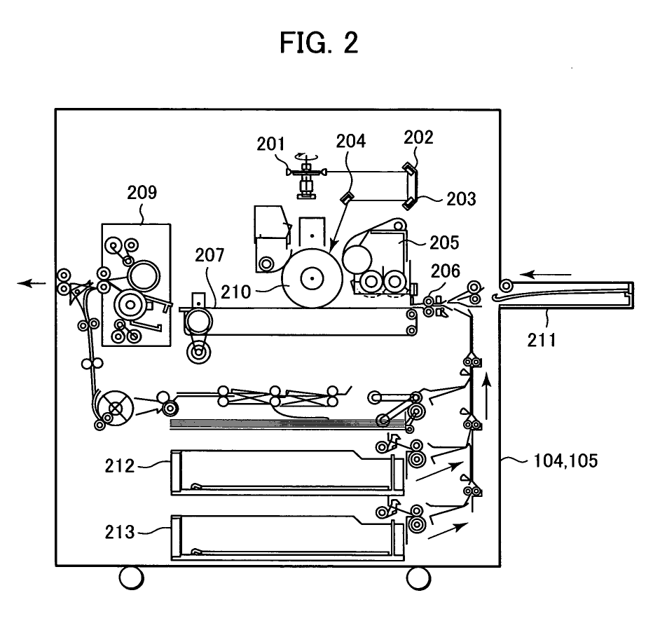

FIG. 2 is a cross-sectional view of the arrangement of the printer engine of an exemplary copier 104. A polygon mirror 201 receives a laser beam emitted by a semiconductor laser. The laser beam passes through mirrors 202, 203 and 204 and scans a photosensitive drum 210. A developing device 205 supplies black toner, and in accordance with the scanning performed by the laser beam, forms a toner image on the photosensitive drum 210. The toner image is transferred to a sheet, and an output image is obtained.

After a sheet has been fed from a sheet cassette 212 or 213, or a manual tray 211, the sheet is passed through registration rollers 206 and is conveyed along a transfer belt 207. Since a toner image has previously been developed on the photosensitive drum 210, as the sheet is conveyed, the toner image is transferred to the sheet in synchronization with the sheet, which supplies the timing. The sheet to which the toner image has been transferred is separated, and the toner image is fixed to the sheet by a fixing device 209. The sheet, after passing through the fixing device 209, is at first guided downward by a flapper, but once the trailing edge of the sheet has passed the flapper, the direction of travel is reversed, and the sheet is discharged. As a result, the sheet is delivered face down, and when printing is performed beginning with the first page, prints are discharged in the correct page order.

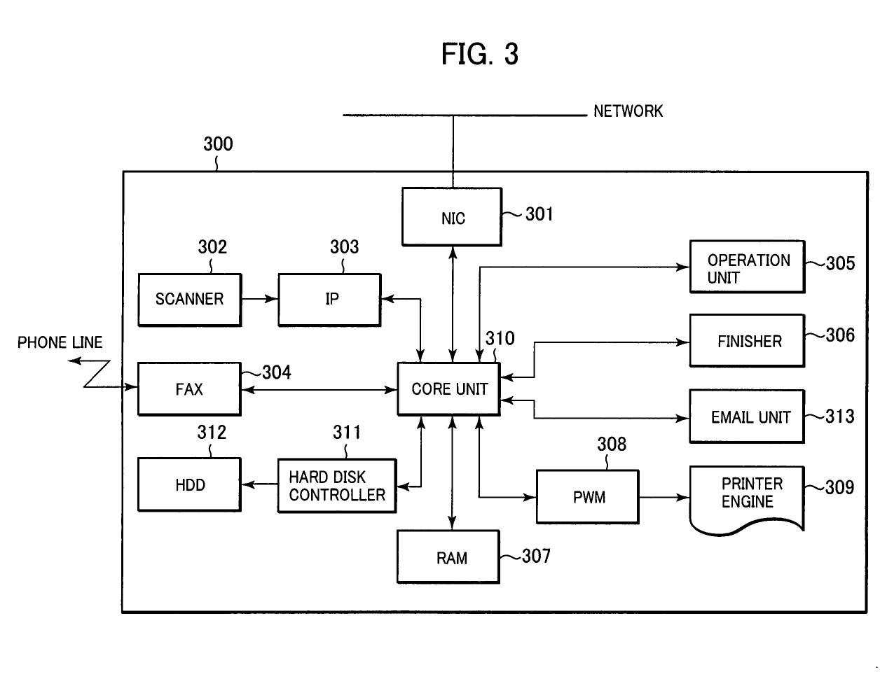

FIG. 3 is a block diagram showing the configuration of a multi-functional apparatus 300 according to exemplary embodiments. A Network Interface Card (NIC) 301 serves as an interface, via a network, between a terminal apparatus, which is an external apparatus, and a core unit 310, which will be described later.

A scanner 302 reads an original image, and transmits, to an image processor (IP) unit 303, image data consonant with the original image that has been read. The IP unit 303 transfers the image data to the core unit 310. The IP unit 303 is an image processor that can perform various image processes.

A FAX unit 304 expands compressed image data received via a telephone line and transmits the expanded data to the core unit 310, or transmits along a telephone line image data compressed by the core unit 310. The image data to be transmitted or the image data received can be temporarily stored in a storage unit 312, such as a hard disk.

An operation unit 305 includes various user interfaces, and by manipulating these user interfaces, the multi-functional apparatus 300 can be employed to perform a desired operation.

A sheet output by a printer engine 309 that will be described later is transmitted to a finisher 306, and a sample tray is changed, in accordance with the job type or the number of sheets to be discharged, and the sheet is discharged.

A random access memory (RAM) 307 is used to temporarily store image data received from the scanner 302 or the NIC 301, or is used as a work memory for a central processing unit (CPU).

A pulse width modulator (PWM) 308 adjusts the pulse width of video data transferred by the core unit 310, and drives a laser beam.

The printer engine 309 records on recording paper, a recording medium, an image consonant with the image data received from the core unit 310.

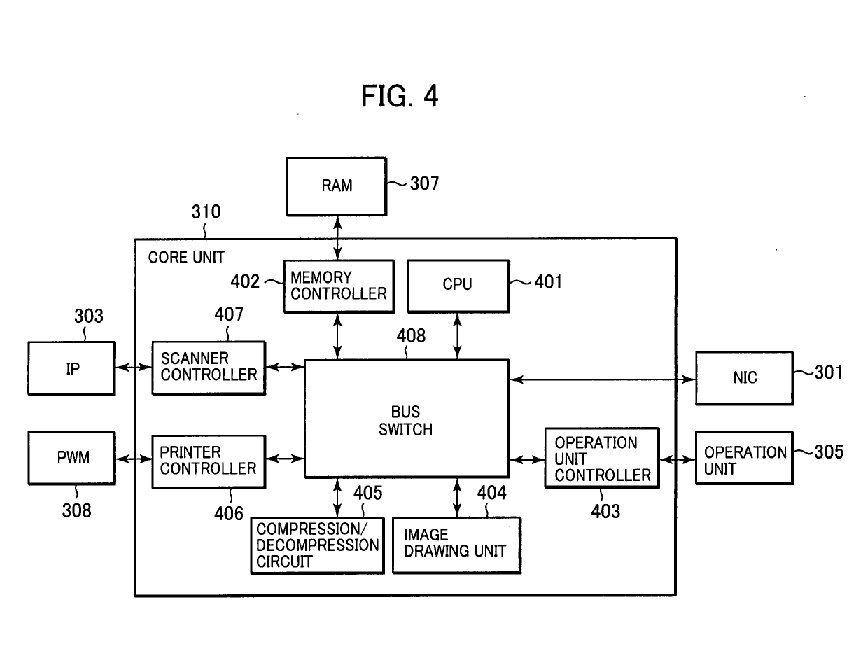

The core unit 310, including an ASIC, controls the transmission of data among the NIC 301, the IP unit 303, the FAX unit 304, the operation unit 305, the finisher 306, the PWM unit 308 and a hard disk controller 311, i.e., it assumes a traffic control role, and changes a bus in accordance with various functions when performed by the multi-functional apparatus 300. The core unit 310 includes a compression/decompression circuit, a memory controller and an image processing circuit for performing a drawing process in FIG. 4.

The hard disk controller 311 is connected to a hard disk 312. The hard disk controller 311 stores on the hard disk 312 an identifier (ID) for performing a search for image data compressed by the core unit 310. Based on code data received via the core unit 310, the hard disk controller 311 searches for the image data stored on the hard disk 312, and reads the compressed image data and transmits them to the core unit 310. The core unit 310 expands the compressed image data and transmits the expanded image data to the individual sections.

A control program for operating the multi-functional apparatus 300 is also stored on the hard disk 312. A fixed area for the box function is also obtained on the hard disk 312, and when the user fetches image data from a computer connected to the multi-functional apparatus, the user need only designate a box number for the image data to be stored in the corresponding box. In exemplary embodiments, when for the box area a defective sector is detected, the defective sector is restored by being replaced with a spare sector in a replacement cylinder on the hard disk 312. Since image data included in the defective sector is naturally invalid data, to transmit a notification to that effect, an email is transmitted to the user of the box in which the image data are included.

In exemplary embodiments, when the defective area detection process has been completed for all the box areas, and a defective sector has been detected, an email unit 313 transmits to the NIC unit 301 an email indicating that image data have been destroyed.

FIG. 4 is a block diagram showing the arrangement for the internal circuit of the core unit 310 in FIG. 3. In FIG. 4, a CPU 401 controls the entire video controller. Reading and writing relative to a RAM 307 and in a work area for the CPU 401 are controlled by a memory controller 402, and PDL expanded image data or image data read by the scanner 302 are stored in the RAM 307. Furthermore, a control program stored on the hard disk 312 is downloaded and stored in the RAM 307.

An operation unit controller 403 controls the operation unit 305. An image drawing unit 404 draws image data in an intermediate language generated from PDL. A compression/decompression circuit 405 compresses image data or expands coded data. A printer controller 406 reads image data from the RAM 307 and transfers image data to the PWM unit 308 in synchronization with the printer engine 309. A scanner controller 407 controls the writing of image data processed by the IP unit 303 to the RAM 307. A bus switch 408 changes a bus from each function module to another module.

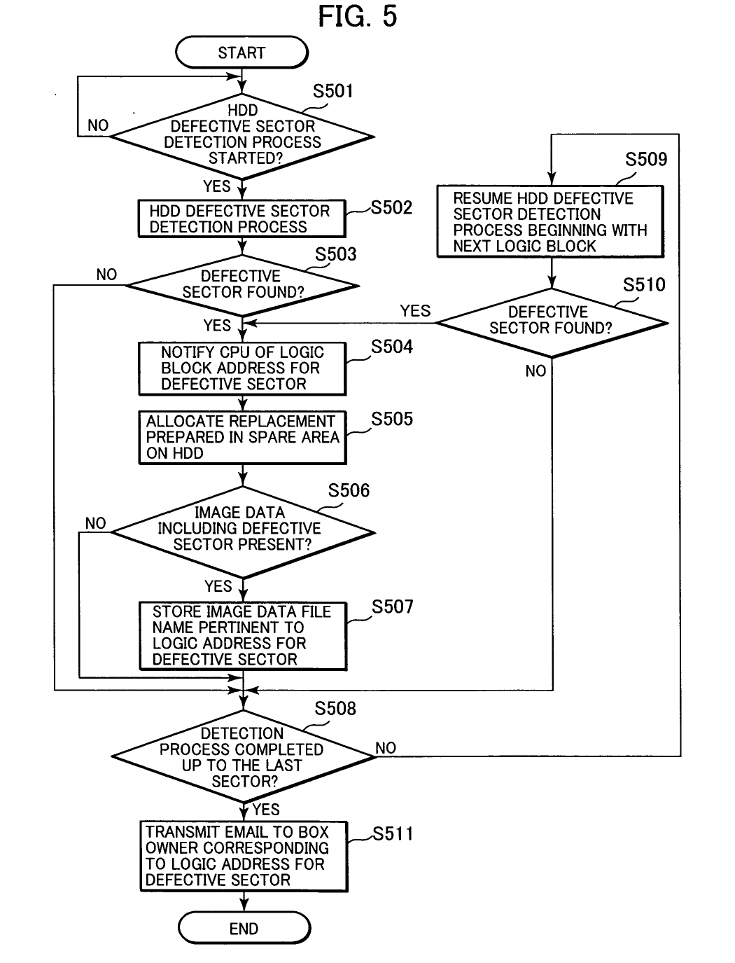

FIG. 5 is a flowchart illustrating an exemplary processing sequence for detecting and restoring a defective sector and for transmitting an email to the user of a box area. First, the operation unit 305 is manipulated to designate a time zone for performing a search for a defective sector in the box area on the hard disk 312. In exemplary embodiments, a late night time zone, when the multi-functional apparatus is less frequently used is designated.

When the time designated by the operation unit 305 is reached (step S501), the CPU 401 transmits a defective sector detection command to the hard disk controller 311, and then, the hard disk controller 311 issues a defective sector detection command to the hard disk 312 to find a defective sector in a box area (step S502).

If no defective sector is found (NO at step S503), the defective sector detection process is terminated and program control returns to the normal process (step S508). When a defective sector is detected (YES at step S503), the hard disk controller 311 transmits, to the CPU 401, a notification, such as “a defective sector is found”, and a logic block address that includes the defective sector (S504). Upon receiving the notification “a defective sector is found”, the CPU 401 issues to the hard disk controller 311 a command to format the defective sector. Generally, when this format command is issued, a process is performed to replace the defective sector with a spare sector in a replacement allocation cylinder that has been prepared in a spare area on the hard disk 312 (step S505).

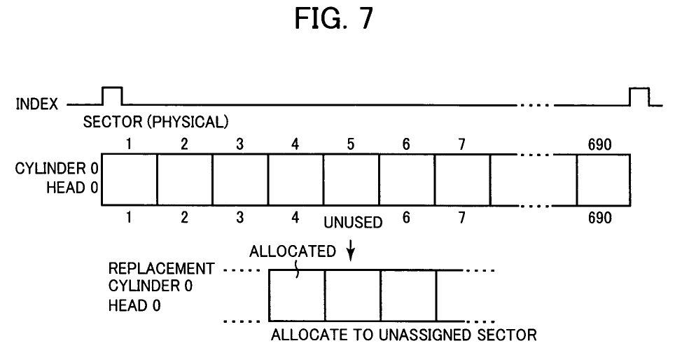

This process will be described while referring to FIG. 7. In the example shown in FIG. 7, the replacement cylinder allocation process for sector 5 is performed for a case of the cylinder 0 and head 0. A spare area called a replacement allocation spare cylinder, which is used when the automatic replacement process for a defective sector is performed, is prepared on the hard disk 312. When an instruction is issued requesting access to physical sector 5, physical sector 5 is allocated to the spare sector as a replacement cylinder on the hard disk 312. Through this process, the sector provided by the replacement cylinder can be accessed, without actually accessing the physical sector 5. In this case, when an access request is also issued for sectors following sector 5, a seek is performed for cylinder 0 and head 0, and the process is continued. Because of the replacement cylinder allocation process, the sectors can be restored hereinafter without employing a defective sector.

When a notification “the restoring of the defective sector is completed” is received from the hard disk 312, the CPU 401 examines a File Allocation Table (FAT) to determine whether the defective sector is an unwritten data area or an area in which image data have already been written (step S506).

When the defective area is an unwritten data area, the defective sector is restored by performing the replacement cylinder allocation process, and the defective sector detection process is again performed at the next logic block address. When the defective sector is an area in which image data have already been written, the image data are invalid, even though the defective sector has been restored by the replacement cylinder allocation process. Therefore, in this event, the multi-functional apparatus 104 notifies the user who owns the image data that includes the pertinent defective sector. First, the logic block address is employed to identify the user to whom the box area that includes the defective area belongs. A table in which box numbers and the email addresses of the box users are entered is stored in the management area on the hard disk 312.

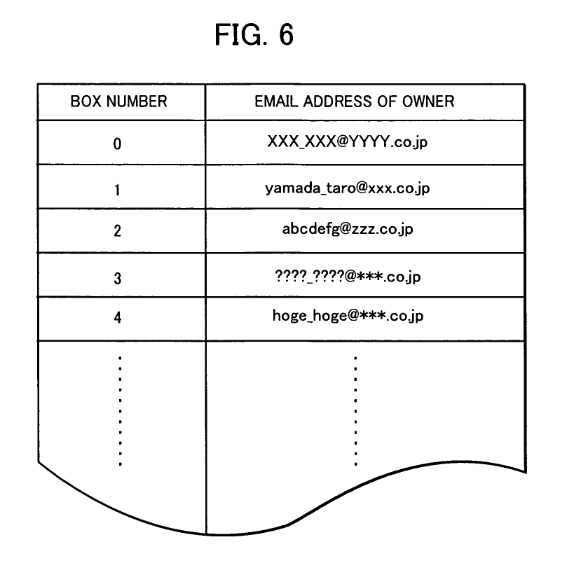

FIG. 6 is a diagram of a management table showing a correlation between the box numbers and the email addresses of the box users. When a user, for example, prepares a new private box in the multi-functional apparatus 104, the user creates a management table by registering a box number and an email address. The email address can be entered by using the operation unit 305, or by the host computer 101, 102 or 103 connected via the network 100.

By examining the management table, the CPU 401 can identify in which box the defective sector is included, and can obtain the email address of the user of the pertinent box. The CPU 401 then stores, on the hard disk 312 or in the RAM 307, the file name for the image data that includes the defective sector (step S507). Thereafter, the same process is repeated from the next logic block address to the last logic block address (steps S508, S509 and S510), and when the decision at S508 is YES, the process up to the last sector is completed.

If there are any defective sectors, the CPU 401 correlates the email address of the box user of the image area that includes the defective sector, which is stored at step S507, with the image file name of image data that includes the defective sector(s). Then, the CPU 401 creates an email indicating that the image data having the image file name have been destroyed, and transmits the email to the email address corresponding to the image file via the email unit 313 (step S511). In exemplary embodiments, an email is created for each image file. Therefore, when a plurality of defective sectors are included in one file, only a single email is required. When a plurality of image files include defective sectors, an email is transmitted to all the users of the corresponding boxes. Thereafter, program control returns to the normal process until the next defective sector detection timing is reached.

As is described above, when a defective sector has been created on a hard disk because a power cutoff or a physical shock occurred while the hard disk was being accessed, or as the result of time-transient deterioration or some another reason, and image data stored in a box have been destroyed, a defective sector detection process is periodically performed, and after restoration of the box has been completed, an email is transmitted to the user of the box. In this manner, a specific user can be appropriately and immediately notified that image data have been destroyed.

An exemplary embodiment of the present invention has been described in detail. However, the present invention is not limited to the configuration of the exemplary embodiment described herein, and can also be applied so long as the functions described in the claims, or the functions provided by the exemplary embodiment are obtained. For example, in the exemplary embodiment described above, an email is transmitted to a user after the restoration of the last sector has been completed, while actually, an email may be transmitted each time the restoration of one image file has been completed, or each time the restoration of one box has been completed. In this case, since a notification is issued immediately after the restoration of an image file or a box has been completed, the user can more quickly be made aware of the situation. Furthermore, since in the above embodiment there is only one email address for the user of a box, when there are a plurality of image files included in a box, the email address of the user of these image files is the same. Thus, whereas in the exemplary embodiment, an email is prepared for each image file, when a plurality of image files that include a defective file are present in the same box, information that a plurality of image files have been destroyed may be collected to prepare a single email, and this email may be transmitted to user of this box. In this case, a single notification is issued to the user for each box. When there are a plurality of boxes in which defective files are present, for those boxes for which the email addresses of the corresponding users are the same, a single notification may be issued for each user.

Further, in the above-described embodiment, a notification of a user was performed after restoration of a defective area; however a notification of a user may be performed at a point in time when a defective area was detected. Furthermore, in the above-described embodiment, an email to the effect that image data in a box have been destroyed is transmitted; however, a simpler instant email may be employed as a notification.

Further, the present invention may be applied for a system constituted by a plurality of apparatuses, or an apparatus that includes only one device. In addition, the purpose of the present invention can also be achieved when a storage medium, on which the program code for software that provides the functions of the above embodiment is recorded, is supplied to a system or an apparatus, and the computer (or, for example, the CPU or the micro-processing unit (MPU)) of the system or the apparatus reads and executes the program code on the storage medium.

In this case, the program code read from the storage medium provides the functions in the above embodiment, and the storage medium on which the program code is stored constitutes the present invention.

The storage medium used to supply the program code can be, for example, a read-only memory (ROM), a floppy disk, a memory card such as a Personal Computer Memory Card International Association (PCMCIA) card or a compact flash, a hard disk, a micro digital audio tape (DAT), a magneto-optical disk, an optical disk such as a compact disk-recordable (CD-R) or a compact disk-rewritable (CD-RW), or a phase change optical disk such as a digital versatile disk (DVD). Or, the program code may be downloaded via a network.

The functions can be provided not only when the computer executes the program code that is read, but also when, based on an instruction in the program code, an Operating System (OS) running on the computer performs part or all of the actual process.

In addition, the present invention can also include a case in which the functions of the embodiment are provided when the program code read from the storage medium is written in a memory prepared in a function extension board, inserted into a computer, or a function extension unit, connected to a computer, and thereafter, based on an instruction in the program code, the CPU included with the function extension board or the function extension unit may perform part or all of the actual process.

According to the invention, when a defective sector has been created by a delay in the box area on the hard disk of the image data management apparatus, and when the box area in which the defective sector has been created is an unused area, the loss of data can be prevented by restoring the defective sector. When the box area is an area in which image data have already been written, the defective sector is restored, and an email indicating that the image data are invalid can be appropriately and immediately transmitted to the user of the box that includes the defective sector. Through this processing, thereafter, a phenomenon where the multi-functional apparatus accesses the defective sector on the hard disk and an incomplete image is reproduced, or even, in the worst case, a phenomenon where a timeout occurs, due to a data retry, and a service call is issued can be avoided.

Moreover, according to the invention, the user of image data can be specified, and from a remote area, the email address can be registered by using an external terminal connected via a network. Further, an image file in which a defective sector is present can be designated by the user.

Furthermore, according to the invention, the detection and restoration of a defective sector can be performed so that the affect produced by the use of the image data management apparatus is minimized. A notification for restoration can be issued for each designated unit, such as each image file, each box or each user, and the detection and restoration of the defective sector can be performed for all the areas.

In addition, according to the invention, since information can be transmitted as a set, emails are transmitted only a small number of times.

As many apparently widely different embodiments of the present invention can be made without departing from the spirit and scope thereof, it is to be understood that the invention is not limited to the specific embodiments thereof except as defined in the appended claims.

The present application claims priority from Japanese Patent Application No. 2004-246617 filed Aug. 26, 2004, which is herein incorporated in its entirety by reference.

What is claimed is:

1. An image data management apparatus connected to a network, the image data management apparatus comprising:
a storage unit adapted to store image data;
a detection unit adapted to detect a defective area in the storage unit;
a management unit adapted to manage information indicating a correlation between a predetermined area in the storage unit and a user corresponding to the predetermined area in the storage unit; and
a notification unit adapted to notify the user corresponding to the predetermined area of information indicating a state of the predetermined area when a defective area in the storage unit detected by the detection unit and the defective area in the storage unit is in the predetermined area.

2. An image data management apparatus according to claim 1, wherein a restoration unit adapted to restore the defective area in the storage unit detected by the detection unit,
the notification unit notifies the user corresponding to the predetermined area of information indicating a state of the predetermined area when the defective area in the storage unit that is restored by the restoration unit is in the predetermined area.

3. An image data management apparatus according to claim 1, wherein the management unit manages information indicating a correlation between the predetermined area in the storage unit and an email address of the user corresponding to the predetermined area in the storage unit, the notification unit transmits an email of information indicating a state of the predetermined area to the email address of the user corresponding to the predetermined area.

4. An image data management apparatus according to claim 2, wherein the notification unit notifies of information indicating that the image data have been destroyed when image data have already been written in the defective area that is restored.

5. An image data management apparatus according to claim 3, further comprising a registration unit adapted to register the email address by using an operation unit of the image data management apparatus or an external terminal connected to the network.

6. An image data management apparatus according to claim 2, wherein the notification unit notifies of information indicating an image file name for the image data when image data have already been written in the medium defective area that is restored.

7. An image data management apparatus according to claim 1, further comprising a setup unit adapted to designate a time zone in which the image data management apparatus is infrequently employed to determine a time for the detection unit to detect a defective area.

8. An image data management apparatus according to claim 1, wherein the detection unit is adapted to detect a defective area for each block in the storage unit, and to repeat a detection process for each block to detect a defective area for all areas in the storage unit.

9. The image data management apparatus according to claim 2, wherein when a plurality of defective areas have been restored and image files that include the plurality of defective areas are the same, the notification unit notifies for each of the image files.

10. An image data management apparatus according to claim 2, wherein when a plurality of defective areas are restored and the predetermined area to which the defective areas belong is identical, the notification unit notifies for each predetermined area.

11. An image data management apparatus according to claim 2, wherein when there are a plurality of predetermined areas where the restored defective areas are present and there is a predetermined area of the predetermined areas for which a corresponding user is identical, the notification unit notifies for each user.

12. An image data management apparatus according to claim 2, wherein the notification unit notifies after the restoration unit restores the defective area in the storage unit.

13. An image data management method, for managing an image data management apparatus connected to a network, the image data management method comprising:
a storage step of storing image data in a storage device;
a detection step of detecting a defective area in the storage device;
a management step of managing information indicating a correlation between a predetermined area in the storage device and a user corresponding to the predetermined area in the storage device; and
notification step of notifying the user corresponding to the predetermined area of information indicating a state of the predetermined area when a defective area in the storage device detected at the detection step and the defective area in the storage device is in the predetermined area.

14. An image data management method according to claim 13, wherein a restoration step of restoring the defective area in the storage device detected at the detection step,
the notification step notifies the user corresponding to the predetermined area of information indicating a state of the predetermined area when the defective area in the storage device that is restored at the restoration step is in the predetermined area.

15. An image data management method according to claim 13, wherein the management step manages information indicating a correlation between the predetermined area in the storage device and an email address of the user corresponding to the predetermined area in the storage device,
the notification step transmits an email of information indicating a state of the predetermined area to the email address of the user corresponding to the predetermined area.

16. An image data management method according to claim 14, wherein the notification step notifies of information indicating that the image data have been destroyed when image data have already been written in the defective area that is restored.

17. An image data management method according to claim 15, further comprising a registration step of registering the email address by using an operation unit of the image data management apparatus or an external terminal connected to the network.

18. An image data management method according to claim 14, wherein the notification step notifies of information indicating an image file name for the image data when image data have already been written in the defective area that is restored.

19. An image data management method according to claim 13, further comprising a setup step of designating a time zone in which the image data management apparatus is infrequently employed to determine a time for the detection step to detect a defective area.

20. An image data management method according to claim 13, wherein a defective area is detected for each block in the storage device at the detection step, and a detection process is repeated for each block to detect a defective area for all areas in the storage device.

21. The image data management method according to claim 14, wherein when a plurality of defective areas have been restored and image files that include the plurality of defective areas are the same, information is notified for each of the image files at the notification step.

22. An image data management method according to claim 14, wherein when a plurality of defective areas are restored and the predetermined area to which the defective areas belong is identical, information is notified for each predetermined area at the notification step.

23. An image data management method according to claim 14, wherein when there are a plurality of predetermined areas where the restored defective areas are present and there is a predetermined area of the predetermined areas for which a corresponding user is identical, information is notified for each user at the notification step.

24. An image data management method according to claim 14, wherein information is notified at the notification step after completion of the restoration step.

25. A computer-executable program, which includes computer-readable program code that attains an image data management apparatus connected to a network, comprising: a storage module for storing image data in a storage device; a detection module for detecting a defective area in the storage device; a management module for managing information indicating a correlation between a predetermined area in the storage device and a user corresponding to the predetermined area; and a notification module for notifying the user corresponding to the predetermined area of information indicating a state of the predetermined area when a defective area in the storage device detected by the detection module and the defective area in the storage device is in the predetermined area.

26. A computer-readable storage medium storing the computer-executable program according to claim 25.
